(19) United States
(12) Patent Application Publication
(10) Pub. No.: US 2013/0230331 A1
(43) Pub. Date: Sep. 5, 2013

(54) IMAGE FORMING APPARATUS

(71) Applicant: CANON KABUSHIKI KAISHA, Tokyo (JP)

(72) Inventor: Norio Takahashi, Suntou-gun (JP)

(73) Assignee: CANON KABUSHIKI KAISHA, Tokyo (JP)

(21) Appl. No.: 13/783,739

(22) Filed: Mar. 4, 2013

(30) Foreign Application Priority Data
Mar. 5, 2012 (JP) 2012-047848
Feb. 22, 2013 (JP) 2013-033017

(51) Int. Cl. G03G 15/00

(52) U.S. Cl. CPC G03G 15/5062; G03G 15/55
USPC 399/24; 399/49

(57) ABSTRACT

An image forming apparatus for forming an image on a recording material, includes: a cartridge, detachably mountable to a main assembly of the image forming apparatus, including a memory and an image forming process member actable on an image bearing member in an image forming process; and an image density measuring portion, provided in the main assembly, for measuring a density of a developer image formed by the image forming process. The memory stores information for discriminating a state of the image forming process member on the basis of the density, measured by the image density measuring portion, of the developer image formed under an image forming condition different from that during normal image formation.

### FIELD OF THE INVENTION AND RELATED ART

The present invention relates to an image forming apparatus of an electrophotographic type or the like and relates to a cartridge recycling detecting system for use with the image forming apparatus.

The image forming apparatus forms the image on a recording material (medium) by using an image forming process such as an electrophotographic process, an electrostatic recording process or a magnetic recording process. Examples of the image forming apparatus may include a copying machine, a printer (LED printer, laser beam printer or the like), a facsimile machine, a word processor and a multi-function machine of these machines. The recording material is a material on which the image is formed by the image forming apparatus, and it is a paper sheet, an OHT sheet, a label or the like. The recording material also includes an intermediary transfer member.

For example, the cartridge is a process cartridge or a developing cartridge, and in a state in which it is detachably mountable to an apparatus main assembly of the image forming apparatus, it acts in an image forming process for forming the image on the recording material. The apparatus main assembly refers to an apparatus constituent portion excluding the cartridge from the constitution of the image forming apparatus.

The process cartridge is prepared by integrally assembling an image bearing member on which a latent image to be formed and at least one of a charging means, a developing means, a cleaning means as process means acting on the image bearing member, into a cartridge, and is detachably mountable to the apparatus main assembly. The image bearing member is an electrophotographic photosensitive member, an electrostatic recording dielectric member, a magnetic recording magnetic member, and the like. The process cartridge can be mounted to and demounted from the apparatus main assembly by a user himself or herself. For this reason, the maintenance of the image forming apparatus can be easily performed.

Therefore, the process cartridge include a cartridge prepared by integrally assembling the image bearing member and the developing means as the image forming process means and being detachably mountable to the apparatus main assembly. The process cartridge which includes the image bearing member and the developing means integrally is called an integral type. Further, the process cartridge which includes the image bearing member and the process means other than the developing means integrally is called the discrete type. That is, the developing means is provided in a developing unit separated from the process cartridge, and the process cartridge, for forming the image, paired up with the developing unit is referred to as the so-called discrete type.

Further, the developing cartridge includes a developing roller (developer carrying member) and accommodates a developer (toner) used, by the developing roller for developing the latent image formed on the image bearing member, and is detachably mountable to the apparatus main assembly. Also the developing cartridge is detachably mountable to the apparatus main assembly by the user himself (herself). For that reason, the maintenance of the apparatus main assembly can be easily performed.

In the case of the developing cartridge, the image bearing member is mounted to the apparatus main assembly or a cartridge supporting member. Or, the image bearing member is provided in the so-called discrete type process cartridge (in this case, the process cartridge does not include the developing means).

Therefore, as for the cartridge, the integral type process cartridge and the discrete type process cartridge are included. Further, the cartridge includes the case where the discrete type process cartridge and the developing cartridge are used in a pair. Further, the cartridge includes the case where the developing cartridge, in which the image bearing member is fixed to the apparatus main assembly or the cartridge supporting member, which is actable on the image bearing member and is detachably mountable to the image bearing member. Further, the cartridge includes a developer cartridge which accommodates the developer (toner) to be supplied to the process cartridge, the developing cartridge, or the like.

In recent years, recycling such that a used (spent) cartridge is collected to realize reuse of parts has been actively made. When the recycling is made, there is a need to discriminate whether or not the cartridge can be disassembled by discriminating whether constituent elements of the cartridge should be disposed of or can be reused. With respect to the constituent elements used for the cartridge, an environment in which the cartridge is to be used, a print number and the like constitute a large discrimination factor for effecting reuse go/no-go (appropriateness) discrimination.

Therefore, into a nonvolatile memory disposed on the cartridge, print number information of the recording material for which the cartridge is used is written. When the cartridge is collected in a recycling factory, the print number information of the recording material is read from the nonvolatile memory in a recycling step, so that whether or not the constituent element of the cartridge is recyclable is discriminated from the print number information. Then, depending on recycling go/no-go discrimination, whether or not the cartridge should be disassembled in the recycling step is determined (Japanese Laid-Open Patent Application (JP-A 2002-278420). Further, a constitution in which with respect to each of the constituent elements of the cartridge, the print number information is stored and then the constituent element is recycled has been proposed (JP-A Hei 8-146837).

However, in the recycling go/no-go discrimination of the cartridge from the print number information cartridge constituent element recycling is not directly discriminated but whether or not the constituent element can be recycled is predicted and discriminated.

Individual cartridges have various use histories and are different in period and temperature/humidity environment in which the cartridge is used. Depending on the use history of the cartridge, even when the print number is the same, there are the cases where the cartridge is recyclable and is not recyclable. For that reason, in the case where the recycling is discriminated from the print number information, accurate recycling discriminating of the constituent element cannot be made, so that disassembling of the cartridge which should not be recycled is made.

### SUMMARY OF THE INVENTION

A principal object of the present invention is to provide an image forming apparatus wherein information capable of directly discriminating a state of a constituent element is stored in a memory provided to a cartridge to be mounted in an image forming apparatus main assembly to effect accurate recycling discrimination of the constituent element.

According to an aspect of the present invention, there is provided an image forming apparatus for forming an image on a recording material, comprising: a cartridge, detachably mountable to a main assembly of the image forming apparatus, including a memory and an image forming process member actable on an image bearing member in an image forming process; and image density measuring means, provided in the main assembly, for measuring a density of a developer image formed by the image forming process, wherein the memory stores information for discriminating a state of the image forming process member on the basis of the density, measured by the image density measuring means, of the developer image formed under an image forming condition different from that during normal image formation.

According to the present invention, in the memory of the cartridge collected in a recycling factory, accurate information for discriminating a state of an image forming process member for the cartridge is stored. Accordingly, in the recycling factory, based on the information stored in the memory, accurate recycling discriminating of the constituent element can be effected. Therefore, an efficiency of a recycling step can be enhanced.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a schematic illustration of an image forming apparatus in Embodiment 1.

FIG. 2 is a block diagram of a control system of the image forming apparatus.

FIG. 3 is a schematic illustration of a density sensor.

FIG. 4 is a control flow chart in Embodiment 1.

FIG. 5 is a schematic illustration showing an example in which a half-tone developer image is formed on a photosensitive drum and is outputted on paper.

FIG. 6 is a graph showing an example of measurement of density fluctuation.

FIG. 7A is a control flow chart (part 1) in Embodiment 2, and FIG. 7B is a control flow chart (part 2) in Embodiment 2.

FIG. 8A is a control flow chart (part 1) in Embodiment 3, and FIG. 8B is a control flow chart (part 2) in Embodiment 3.

### DESCRIPTION OF THE PREFERRED EMBODIMENTS

### Embodiment 1

### (1) Image Forming Portion

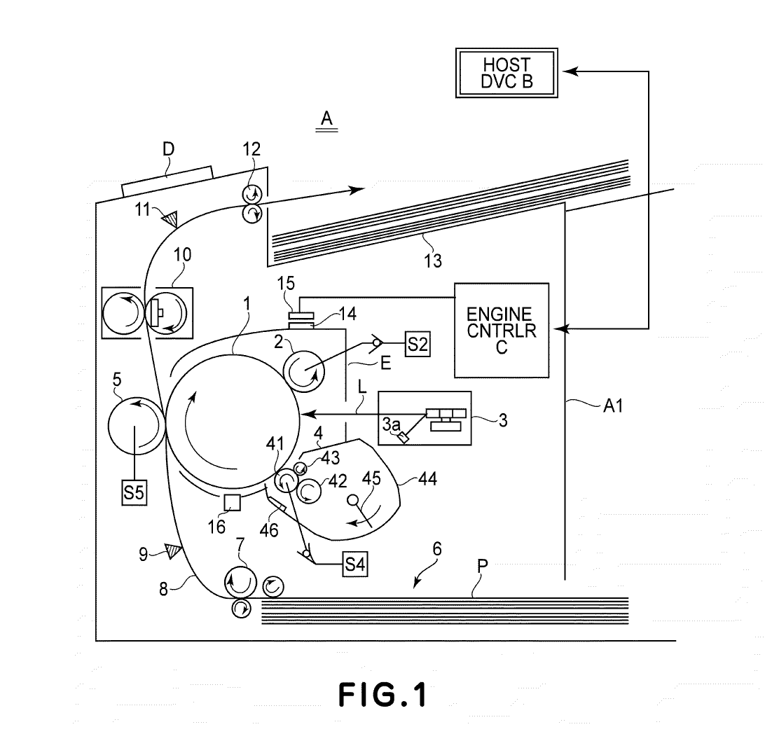

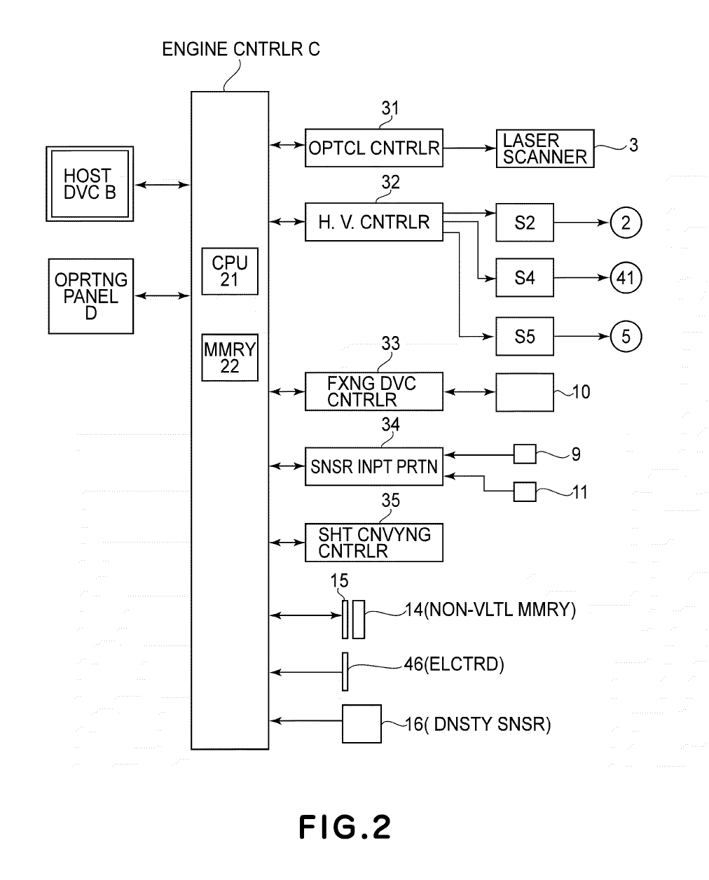

FIG. 1 is a schematic illustration of an example of an image forming apparatus according to the present invention or an image forming apparatus using a recycling detecting system of a cartridge according to the present invention. FIG. 2 is a block diagram of a current system of an image forming apparatus A.

This image forming apparatus A is an electrophotographic laser printer of a process cartridge mounting and demounting type, and on the basis of image information (electric image signal) inputted from a host device B into an engine controller (control means) C, an image is formed on a sheet-like recording material (recording medium) P. The host device B is a personal computer, an image reader, a network, a facsimile machine or the like.

The engine controller C includes CPU 21 and memory (ROM, RAM) 22 and transfers various pieces of electrical information between itself and the host device B or an operating panel D. Further, the engine controller C effects integrated control of an image forming operation (print operation) of the image forming apparatus A in accordance with a predetermined control program or reference table held in a memory 22.

A cartridge E is detachably mountable to an apparatus main assembly (image forming apparatus main assembly) A1 of the image forming apparatus A, and is a cartridge including a memory and an image forming process member actable on a rotatable image bearing member in an image forming process in a state in which the cartridge E is mounted in the apparatus main assembly A1. The cartridge E will be specifically described later in (2).

The apparatus A includes an electrophotographic photosensitive drum 1 as the rotatable image bearing member. In this embodiment, the drum 1 is prepared by successively applying, as a photosensitive layer, a charge generating layer and a charge transporting layer on an outer peripheral surface of an aluminum cylinder. The drum 1 is rotationally driven in the clockwise direction indicated by an arrow at a predetermined peripheral speed (process speed). At a periphery of this drum 1, as an image forming process means (image forming process member) actable on the drum 1, a charging means 2, an exposure means 3, a developing means 4 and a transfer means 5 are provided along a rotational direction.

The charging means (charging member) 2 is a means for electrically charging the surface of the drum 1 and is a charging roller in this embodiment. The charging roller 2 is an electroconductive roller formed in a roller shape by forming an electroconductive urethane rubber layer around a core metal coaxially and integrally so as to have an ASKER-C hardness of 50-70 degrees.

The charging roller 2 is arranged in parallel to the drum 1 and is provided while being urged at a predetermined urging force, and is a rotatable member which is to be rotated by rotation of the drum 1. To the charging roller 2, a charging bias having a predetermined polarity and a predetermined potential is applied from a charging (bias) power (voltage) source portion S2, so that the outer peripheral surface of the drum 1 is control-charged uniformly to a predetermined charge potential Vd (dark portion potential).

The exposure means 3 is an exposure device for forming a latent image on the drum 1, and in this embodiment, is a laser scanner for scanning the uniformly charged surface of the drum 1 with a laser beam by a semiconductor layer 3a. That is, the uniformly charged surface of the rotating drum 1 is subjected by the scanner 3 to the scanning exposure to laser light L modulated depending on the image information, so that the potential of the drum 1 at an exposed portion is attenuated from the dark portion potential Vd to a light portion potential Vl. By a potential contrast between the dark portion potential Vd and the light portion potential Vl, the latent image (electrostatic latent image) corresponding to the image information for the laser light L to which the peripheral surface of the drum is exposed is formed.

The developing means 4 is a means for developing, as a developer image, the latent image formed on the surface of the drum 1. In this embodiment, the developing means 4 is a reverse developing device of a control type using a non-magnetic one-component developer.

The developing device includes a developing roller 41 as a rotatable developer carrying member for developing, with a developer, the latent image held on the drum 1. Further, the developing device includes a supplying roller (developer supplying member) 42 for supplying the developer to the developing roller 41 and includes a regulating roller (developer layer thickness regulating member) 43 for regulating an amount of the developer to be placed on the developing roller 41. Further, the developing device includes a developer accommodating portion (developer accommodating container) 44 in which the developer (not shown) to be supplied to the developing roller 41 is accommodated, a stirring member 45 for feeding the developer toward the supplying roller (developer supplying member) 42 while stirring the developer in the developer accommodating portion 44, and the like member.

The developing roller 4 is, similarly as the charging roller 2, an electroconductive roller formed in a roller shape by forming an electroconductive urethane rubber layer around a core metal coaxially and integrally so as to have an ASKER-C hardness of 50-70 degrees. The developing roller 4 is arranged in parallel to the drum 1 and is provided while being urged at a predetermined urging force, and is rotationally driven in the counterclockwise direction indicated by an arrow at a speed ratio R thereof with respect to a rotational speed of the drum 1.

The supplying roller 42 is an elastic sponge roller is arranged in parallel to the developing roller 41 and is provided while being urged at a predetermined urging force in a side opposite from the drum side of the developing roller 41. The supplying roller 42 is rotationally driven in a direction opposite to the rotational direction of the developing roller 41 at a control portion thereof with the developing roller 41, thus supplying the developer to the surface of the developing roller 41.

The regulating roller 43 is an elastic roller is arranged in parallel to the developing roller 41 and is provided while being urged at a predetermined urging force in a downstream side of the supplying roller 42 with respect to the rotational direction of the developing roller 41. The regulating roller 43 is rotationally driven in a direction opposite to the rotational direction of the developing roller 41 at a control portion thereof with the developing roller 41 to regulate an amount of the developer supplied to the surface of the developing roller 41 by the supplying roller 42, thus uniformly adjusting the developer layer on the surface of the developing roller 41 in the small thickness.

The developer accommodated in the developer accommodating portion 44 is the non-magnetic one-component developer in this embodiment, and is a negative developer (negative toner) having the same charge polarity as the drum 1. The developer carried on the developing roller 41 is electrically charged to the same polarity as the charge polarity of the drum 1 by friction of the supplying roller 42 and the regulating roller 43 with the developing roller 41.

To the developing roller 41, a predetermined developing bias (DC voltage+AC voltage) is applied from a developing (bias) power source portion S4. As a result, at a developing portion which is a contact portion between the drum 1 and the developing roller 41, the developer in the developing roller 41 side is selectively transferred onto the drum 1 in a region of the light portion potential Vl, so that the latent image in the drum 1 side is reversely developed as the developer image.

The transfer means 5 is a means for transferring the developer image, formed on the drum 1, onto the recording material (recording medium) P, and is a transfer roller in this embodiment. The transfer roller 5 is an electroconductive elastic roller, and is arranged in parallel to the drum and is provided while being urged at a predetermined urging force. The transfer roller 5 is rotated by the rotation of the drum 1. Into a transfer nip which is a contact portion between the transfer roller 5 and the drum 1, the recording material P is introduced at predetermined control timing from a sheet feeding portion side and then is nipped and conveyed.

During a period from the introduction of the recording material P into the transfer nip until the recording material P completely passes through the transfer nip, a transfer bias which has an opposite polarity to the charge polarity of the developer and which has a predetermined potential is applied from a transfer (bias) power source portion S5. As a result, the developer image in the drum 1 side is successively transferred electrostatically onto the recording material P passing through the transfer nip.

Sheets of the recording material P are stacked and accommodated in a sheet feeding portion 6 at a lower portion in the image forming apparatus A. At predetermined control timing, the sheet feeding roller 7 is driven, so that a sheet of the recording material P in the sheet feeding portion 6 is separated and fed. The recording material P passes through a conveying path 8 and is introduced into the transfer nip, where the developer image is transferred onto the recording material P. A top sensor 9 for achieving synchronization with the conveyance of the recording material P is provided to the conveying path 8.

The recording material P coming out of the transfer nip is separated from the surface of the drum 1 and then is introduced into a fixing device 10, where an unfixed developer image on the recording material P is fixed as a fixed image. Then, the recording material P coming out of the fixing device 10 is discharged, as an image-formed product, onto a sheet discharge tray 13 by a sheet discharging roller pair 12. A sheet discharge sensor 11 for detecting the presence or absence of the recording material P after the fixing is provided.

Referring to FIG. 2, the engine controller C controls an optical system controller 31 for controlling the laser scanner 3, a high-voltage controller 32 for controlling output of each of high voltages in steps of the charging, the development, the transfer and the like, and a fixing device controller 33 for controlling a temperature of the fixing device 10. Further, the engine controller C controls a sensor input portion 34 for detecting a paper presence/absence state of the sheet discharge sensor 11, and a sheet conveyance controller 35 for effecting drive/stop of motor/roller and the like for conveying the recording material P.

### (2) Cartridge E

In the image forming apparatus A in this embodiment, the developing roller 2 and the developing device 4 which are process means actable on the drum 1 are integrally assembled into the cartridge (process cartridge of the integral type) E detachably mountable to a predetermined mounting portion of the apparatus main assembly A1.

The cartridge E is mounted to the predetermined mounting portion in the apparatus main assembly 1A in a predetermined manner. Further, the cartridge E is demounted from the predetermined mounting portion in the apparatus main assembly 1A in a predetermined manner. That is, the cartridge E is used by being replaced with a new one.

In a state in which the cartridge E is mounted to the mounting portion in the apparatus main assembly 1A in the predetermined manner, a drive and bias input portion (not shown) in the cartridge E side is connected to a drive and bias output portion in the apparatus main assembly A1 side. As a result, a driving force of a driving source in the apparatus main assembly A1 side is transferred to the cartridge E side to drive the drum and the developing roller 41, supplying roller 42, regulating roller 43 and stirring member 45 of the developing device 4.

Further, a bias of a power source portion in the apparatus main assembly A1 side is applied to the cartridge E side, so that the charging bias application to the charging roller 2 and the developing bias application to the developing roller 41 are effected. That is, the apparatus A is capable of performing an image forming operation.

Further, the cartridge E includes a memory (storing means) 14 capable of reading and writing various pieces of information. The cartridge E may preferably include a non-volatile memory. In a state in which the cartridge E is mounted to the mounting portion in the apparatus main assembly A1 in the predetermined manner, an information transmitting portion (communicating means) 15 of the apparatus main assembly A1 side is in a state in which it opposes the memory 14. As a result, the engine controller C is capable of transferring the information with respect to the memory 14 via the information transmitting portion 15, so that the CPU 21 communicates with the memory 14 to effect reading and store (writing) of the information. The memory provided to the cartridge E may also be only required to store a signal sent from the controller without performing the transfer of the information with respect to the apparatus main assembly A1. That is, if the memory can store the information for discriminating a state of the image forming process member, this function of the memory is sufficient as a minimum function of the memory.

In the cartridge E, the developer accommodated in the developer accommodating portion 44 is gradually consumed with its use for image formation. Then, the developer is consumed until the image of such a quality that the use can satisfy is unable to be formed, so that the cartridge E reaches an end of its operation lifetime.

Therefore, in this embodiment, a remaining developer amount detecting means for detecting a remaining developer amount of the developer accommodating portion 44 is provided. Further, in the engine controller C, a detected remaining developer amount is compared with a threshold (predetermined value), for cartridge lifetime prewarning or warning, set in advance. When the remaining developer amount value reaches the threshold, the lifetime prewarning or lifetime warning of the cartridge E is displayed at a displaying portion of an operating panel portion D or at a displaying portion of the host device B. As a result, the user is urged to prepare a (new) cartridge E for replacement or is urged to replace the cartridge E.

As the remaining developer amount detecting means for detecting the remaining developer amount of the developer accommodating portion 44, various means can be used. In this embodiment, an electrode 46 as the remaining developer amount detecting means for detecting the remaining developer amount is provided in the neighborhood of the developing roller 41 in the developer accommodating portion 44. When the developer in the developer accommodating portion is gradually consumed, then electrostatic capacity between the developing roller 41 and the electrode 46 is decreased with a decrease of the developer in a space interposed between the developing roller 41 and the electrode 46. That is, there is a correlation between the developer amount in the developer accommodating portion 44 and the above electrostatic capacity.

Therefore, correlation data between the developer amount in the developer accommodating portion 44 and the above electrostatic capacity is stored (held) in advance in a memory 22 provide din the engine controller C. The engine controller C can detect the remaining developer amount in the developer accommodating portion 44 from the electrostatic capacity measured by the electrode 46 and the above correlation data stored in the memory 22.

The detection (method) of the cartridge lifetime is not limited to a method using the above-described remaining developer amount detection. In the process cartridge E of the integral type, the cartridge lifetime detection can also be made by detecting a lifetime of the drum 1. A film thickness of the photosensitive layer (charge generating layer) of the drum 1 is gradually decreased by continuous image formation. Therefore, as an example of the detecting means of the drum lifetime (cartridge lifetime), the drum lifetime can be discriminated by detecting an increase of a current value during constant voltage application to the drum 1.

This is because during the constant voltage application, an AC current passing between the drum and the charging means is increased with a decrease in thickness of the drum by the continuous image formation. That is, when the film thickness of the drum is decreased to reach a certain film thickness, drum lifetime discrimination can be made by determining the AC current flowing at that time.

The cartridge lifetime detection can be performed also by other various means such as detection by comparison between an integrated sheet passing number (integrated number of image formation) and a predetermined threshold, detection by comparison between a residual (waste) toner stagnation value of a residual toner accommodating portion and a predetermined threshold in the case where a drum cleaner is provided, and the like detection.

### (3) Cartridge Recycling Detecting System

The used (spent) cartridge demounted from the apparatus main assembly A1 by the user on the basis of the lifetime prewarning or lifetime warning of the cartridge E is collected in a recycling factory. Then, in the case where the constituent element (image forming process member) of the collected used cartridge is recyclable, disassembling of the cartridge is performed in a recycling step, so that a recyclable constituent element is demounted. Then, recycling is made as desired and then the constituent element is reused as the constituent element for a new cartridge.

Here, the case where the constituent element of the used cartridge is recyclable means that even when the constituent element is reused as the constituent element for the new cartridge, the constituent element is in a state, in which image defect is not generated during the use, through the lifetime of the cartridge within an operation coverage range.

In the present invention, as described below, with respect to the used cartridge collected in the recycling factory, recycling detection of the constituent element is directly made by the image forming apparatus main assembly in which the cartridge is mounted and used. Further, recycling go/no-go discrimination information or information for performing recycling go/no-go discrimination is stored in the memory 14 of the cartridge E.

Therefore, in the recycling factory, by reading out the recycling go/no-go discrimination information or information for performing recycling go/no-go discrimination stored in the memory 14 of the collected used cartridge E, accurate recycling discrimination of the constituent element can be made. That is, a recyclable cartridge and a non-recyclable cartridge are accurately screened, so that only the recyclable cartridge can be subjected to a disassembling step.

Accordingly, it is possible to eliminate such an inconvenience that accurate recycling discrimination of the constituent element cannot be made and disassembling of the non-recyclable cartridge is also performed as in a conventional case where the recycling discriminating is made on the basis of the print number information (image formation history information), so that an efficiency of the recycling step can be enhanced.

In the following, the recycling detecting system for the cartridge E in this embodiment will be described. In this embodiment, an example in which an image density measuring means 16 for measuring a density of the developer image formed on the drum 1 by the image forming process is used for discriminating whether or not the developing roller 41 as the image forming process member provided to the cartridge E will be described. The image density measuring means 16 is referred to as a density sensor below.

In this embodiment, the density sensor 16 is provided in the image forming apparatus main assembly A1. Further, the density sensor 16 opposes, in a state in which the cartridge E is mounted in the apparatus main assembly A1, the surface of the drum 1 in a side downstream of the developing roller 41 and upstream of the transfer roller 5 with respect to the rotational direction of the drum 1. That is, in order to measure the density of the developer image on the drum 1, the density sensor 16 was provided so as to be close to the drum 1 after passing through the developing portion.

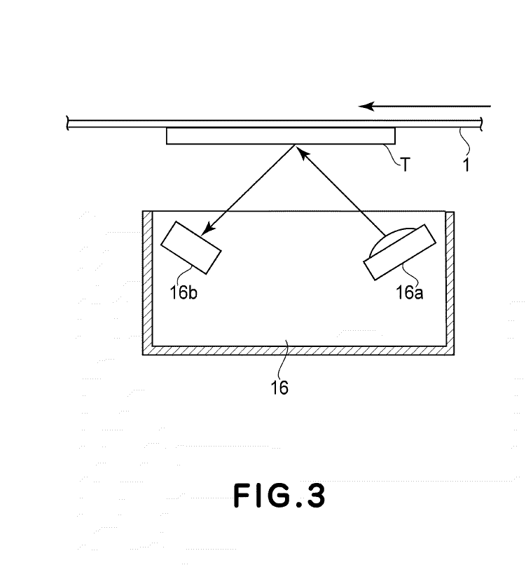

FIG. 3 is a schematic illustration of the density sensor 16. The density sensor 16 includes a light emitting portion 16a and a light receiving portion 16b. The developer image T formed on the surface of the drum 1 is irradiated with spot light (beam) from the light emitting portion 16a and then reflected light from the developer image T is received by the light receiving portion 16b, so that the density of the developer image T is detected by a quantity of the received light. A density detection signal from the light receiving portion 16b is inputted into the CPU 21 of the engine controller C. A relationship between the density and the density detection signal is stored as a conversion table in the memory 22.

Next, a method of the recycling go/no-go discrimination of the developing roller 41 by using the density sensor 16 will be described. Generally, power of electrically charging the developer on the developing roller 41 is lowered in an initial stage of use than in the latter stage of use. When the charging power is lowered, “fog” such that the developer is deposited on the drum 1 at a non-image portion is liable to occur. In this embodiment, the density for evaluating a degree of the fog is measured by using the density sensor 16, and the degree of the fog is evaluated as occurrence of fog in the case where the measured density exceeds a threshold, and is evaluated as no occurrence of fog in the case where the measured density is not more than the threshold. Here, with respect to the developing roller 41, the charging power is lowered with the use of the developing roller 41 and therefore it would be considered that the following three states A, B and C are created.

State A: Fog occurrence before and after recycling.

State B: No fog occurrence before recycling but fog occurrence after recycling.

State C: No fog occurrence before and after recycling.

The developing roller 41 for which the fog occurs is not suitable for the recycling, and therefore the state A and the state B are evaluated as “recycling disable”, and the state C is evaluated as “recycling enable”. In general, the degree of the fog in the state C is less than that of the fog in the state B. However, in both of the state B and the state C before the recycling, the degree of the fog is small and thus a difference in fog between the states B and C is small. Therefore, the state of the fog cannot be discriminated with accuracy.

Therefore, in this embodiment, the engine controller C executes the following operation in a control mode in order to discriminate the state of the developing roller 41 as the image forming process member provided to the cartridge E.

That is, the developer image is formed under an image forming condition (different from that during normal image formation) in which the fog is liable to occur more than under the image forming condition during the normal image formation, and then whether or not the fog density is not more than a predetermined threshold is discriminated. As a result, whether or not the developing roller 41 is recyclable can be discriminated with accuracy.

In this embodiment, as the image forming condition in which the fog is liable to occur, the following condition was set. When the charge potential (dark portion potential) of the drum 1 is Vd, a DC voltage of the developing bias to be applied to the developing roller 41 is Vder, and an absolute value of a difference between Vd and Vdev is Vback, the image is formed under a condition in which Vback is larger than that in a condition at the time of normal image formation.

Then, the engine controller C effects the recycling go/no-go discrimination of the developing roller 41 on the basis of the state of the fog of the developer image, formed on the drum 1, of which density is detected by the density sensor 16. That is, the state A and the state B are evaluated as “recycling disable”, and the state C is evaluated as “recycling enable”. Then, a discrimination result is written in the non-volatile memory 14 of the cartridge E.

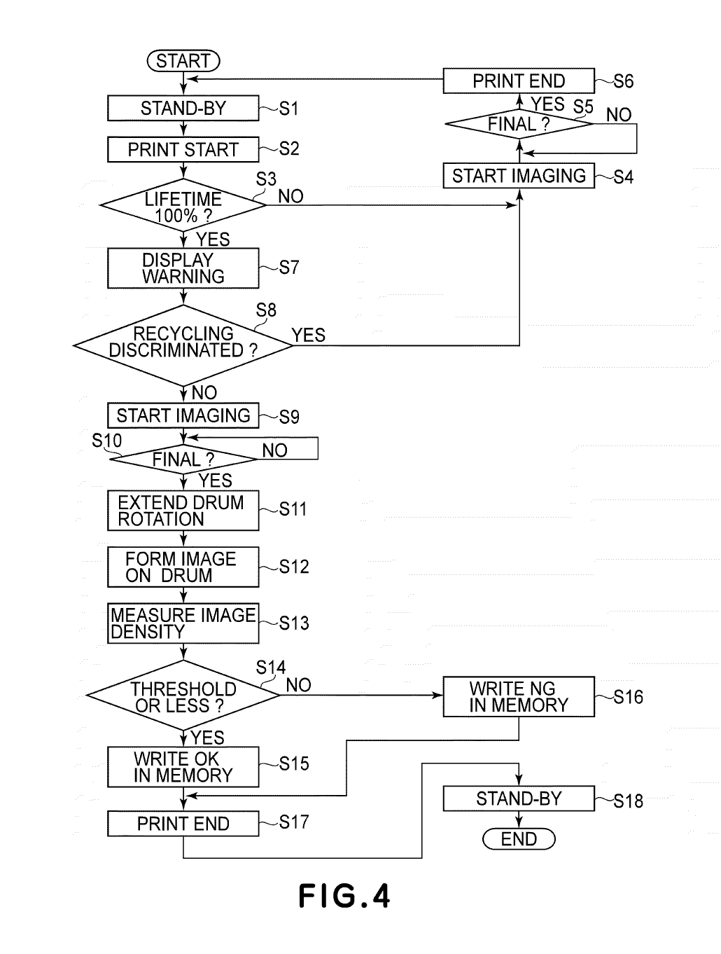

FIG. 4 shows a control flow chart of the image forming apparatus in this embodiment. In a stand-by state (state in which a main motor is stopped and the image forming apparatus A waits for input of a printer command) of the image forming apparatus (step S1), the engine controller C receives the printer command. Then, the engine controller C actuates the main motor of the image forming apparatus to start a printing (operation) (S2: pre-rotation step as a preparation operation before image formation).

The engine controller C discriminates, at the time of the print start, whether or not the drum lifetime of the cartridge E mounted in the apparatus main assembly A1 is 100% by a lifetime calculating means, of the drum 1, using the drum lifetime detecting means as described above (S3).

When the drum lifetime does not reach 100%, the image formation of an inputted print job is started. Then, when printing of a predetermined number of sheets is effected, the printing is ended (post-rotation step as an ending operation after the image formation) and the main motor is turned off to place the image forming apparatus in the stand-by state (S4 to S6 and S1).

Further, in step S3, in the case where the drum lifetime is discriminated as 100%, the engine controller C displays lifetime prewarning or lifetime warning of the cartridge E at the displaying portion of the operating panel portion D or at the displaying portion of the host device B (S7). Further, whether or not the developing roller 41 has already been subjected to the recycling go/no-go discrimination is discriminated (S8). When the charging roller 2 has already been subjected to the recycling go/no-go discrimination, the engine controller C starts the image formation of the inputted print job and then ends the printing when the printing of a predetermined number of sheets is effected, and thereafter turns off the main motor to place the image forming apparatus in the stand-by state (S4 to S6 and S1).

In step S8, when the developing roller 41 has not been subjected to the recycling go/no-go discrimination, the engine controller C starts the image formation of the inputted print job and then executes printing of a predetermined number of sheets (S9 and S10). Then, the drum rotation after end of the printing of the predetermined number of sheets is extended (S11). Then, the condition is changed to the image forming condition for discriminating the state of the developing roller 41, and then the developer image for depositing the developer causing the fog is formed on the drum 1 (S12). Then, by using the density 16, the density of the developer image capable of causing the fog by the deposition of the developer on the drum 1 at the non-image portion is measured (S13).

A measured value (fog density measurement result) and a predetermined threshold are compared (S14). When the fog density measurement result is not more than the predetermined threshold, discrimination that a degree of consumption of the developing roller 41 is small and thus the developing roller 41 is recyclable is made, and then the state in which the developing roller 41 is recyclable is written in the non-volatile memory 14 (S15).

The predetermined threshold is, when the fog density measurement result is not more than the predetermined threshold, set at a value at which discrimination that image defect is not generated during use through the lifetime of a brand-new cartridge in an operation coverage range even when the developing roller 41 of the cartridge is reused as the developing roller 41 of the brand-new cartridge can be made.

Further, when the fog density measurement result exceeds the predetermined threshold, the degree of consumption of the developing roller 41 is large. That is, the brand-new cartridge lifetime in the operation coverage range cannot be warranted even when the developing roller 41 of the cartridge is reused as the developing roller 41 of the brand-new cartridge, i.e., the developing roller 41 is discriminated as being “recycling disable”. Then, with respect to the developing roller 41, “recycling disable” is written in the non-volatile memory 14 (S16).

Then, the printing is ended (post-rotation) (S17), and the main motor is turned off to place the image forming apparatus in the stand-by state (S18).

In the above steps, the steps S11 to S16 constitute the operation in the control mode for discriminating the state of the image forming process member (the developing roller 41 in this embodiment) provided to the cartridge E. In the operation in the control mode, the developer image is formed under the image forming condition (in which the fog is liable to occur more than under the image forming condition during the normal image formation in this embodiment) different from that during the normal image formation. Then, the density of the formed developer image is measured by the density sensor (image density measuring means) 16, and then the state of the image forming process member is discriminated from a measured density value. Thereafter, a discrimination result is stored in the non-volatile memory 14.

In this embodiment, as described above, the lifetime calculating means of the drum 1 is provided, and the engine controller C executes the operation in the control mode (S11 to S16) when the drum lifetime (image bearing member lifetime) calculated by the lifetime calculating means reaches a predetermined value.

As described above, the fog density is measured under the image forming condition different from that during the normal image formation to discriminate the state of the developing roller 41, so that the recycling go/no-go discrimination of the developing roller 41 can be made with accuracy. By writing the recycling go/no-go information of the developing roller 41 into the non-volatile memory 41, it becomes possible to eliminate the recycling discriminating step (e.g., a step of reading the image forming information from the non-volatile memory to discriminate the necessity or unnecessity of the recycling) in the factory.

Here, calculation of the drum lifetime will be described on the basis of description in JP-A 2006-106692. As information relating to the cartridge use amount, information on drum use amount calculated based on the drum rotation time is used. This corresponds to a use amount of a photosensitive drum computed on the basis of a damage index of the photosensitive drum disclosed in Japanese Patent No. 3285785.

In the memory in the cartridge, pieces of information such as cartridge drive time information T, drum use amount operational expression coefficient information φ as weighting coefficient for computing the photosensitive drum use amount, photosensitive drum use amount threshold information α, and information showing a table for setting an image forming condition correspondingly to the photosensitive drum use amount threshold information α.

The photosensitive drum use amount threshold information α and the drum use amount operational expression coefficient information φ are stored in the memory during shipping of the cartridge. These values change depending on sensitivity of the drum, a drum material, a contact pressure of a cleaning blade, and an electric characteristic of the charging roller and therefore are stored in the memory of individual cartridge, and then the cartridge is shipped.

When the print signal is received by the image forming apparatus main assembly, the cartridge is driven by a photosensitive member rotation instruction portion, so that an image forming process is started. In this case, the drum use amount is calculated in the following manner.

An integrated value of photosensitive drum rotation time data (corresponding to the above-described cartridge drive time information T) from the photosensitive member rotation instruction portion is B. An integrated value of charging bias application time data from a charging bias application time detecting portion is A. By a conversion formula D=A+B×φ using the weighting coefficient φ read from the memory, a drum use amount D is calculated by a computing portion and then is integrated and stored in a main assembly memory for main assembly storage.

The photosensitive drum rotation time data and the charging bias application time data are stored in the memory at any time, and the data computing of the drum use amount is performed in real time when the drive of the photosensitive drum is stopped. In place of storage of the photosensitive drum rotation time data and the charging bias application time data in the memory, the drum use amount D as the result of the computing may also be written in the memory.

From the photosensitive drum lifetime warranted by a manufacturer, a predetermined drum use amount W0 is calculated and stored in the memory. A drum use amount W1 during use of the cartridge is stored in the memory by the above-described method. Here, the drum lifetime is defined as: (drum lifetime)=(W1/W0)×100(%).

In this embodiment, with respect to timing of the recycling go/no-go discrimination of the developing roller 41, the method effected by detecting the drum lifetime is described, but the timing is not limited to that in this embodiment but may also be timing of the number of passing sheets, and the like timing so long as at the timing, the lifetime of the cartridge E is similarly detectable.

### Embodiment 2

In Embodiment 1 described above, the fog density on the drum 1 was measured by using the density sensor 16 in order to effect the recycling go/no-go discrimination of the developing roller 41 as the developer carrying member. On the other hand, in this embodiment, in order to effect the recycling go/no-go discrimination of a rotatable image forming process member in the cartridge E, density measurement of the developer image on the drum 1 is performed by using the density sensor 16. In the description of this embodiment, repeated portions of Embodiment 1 will be omitted from redundant description.

Similarly as in Embodiment 1, in order to measure the density of the developer image on the drum 1, the density sensor 16 was provided so as to close to the surface of the drum 1 after passing through the developing portion. The density sensor 16 was disposed at a longitudinal central position of the drum 1 with respect to a rotational axis direction of the drum 1.

In this embodiment, the remaining developer amount detecting means 46, as described above, for detecting the remaining amount of the developer in the developer accommodating portion 44 in which the developer to be supplied to the developing roller 41 of the developing device 4 is accommodated is provided in the cartridge E. The engine controller C executes an operation in a control mode, in which recycling go/no-go discrimination of a rotatable member in the cartridge E, when a remaining developer amount detected by the remaining developer amount detecting means 46 reaches a predetermined value.

Next, a method of making recycling go/no-go discrimination of the rotatable member in the cartridge E by using the density sensor 16 will be described. In this embodiment, a contact charging type in which the charging roller 2 is contacted to the drum 1 and is rotated by rotation of the drum 1 is employed. Further, a contact developing type in which the developing roller 41 is rotated in contact with the drum 1 is employed. The developing roller 41 is rotated at a peripheral speed ratio R relative to a rotational speed of the drum 1.

The drum 1 is prepared by applying the charge generating layer and the charge transporting layer on the aluminum cylinder. Further, the charging roller 2 and the developing roller 41 are prepared by using urethane rubber as their material. By using the charging roller 2 and the developing roller 41 which have the ASKER-C hardness of 50-70 degrees, stable contact with the drum 1 is realized.

The drum 1 including the metal member as the base material is harder than the charging roller 2 and the developing roller 41. For this reason, when the drum 1 is contacted to the charging roller 2 or the developing roller 41 for a long term, the charging roller 2 or the developing roller 41 is deformed in shape.

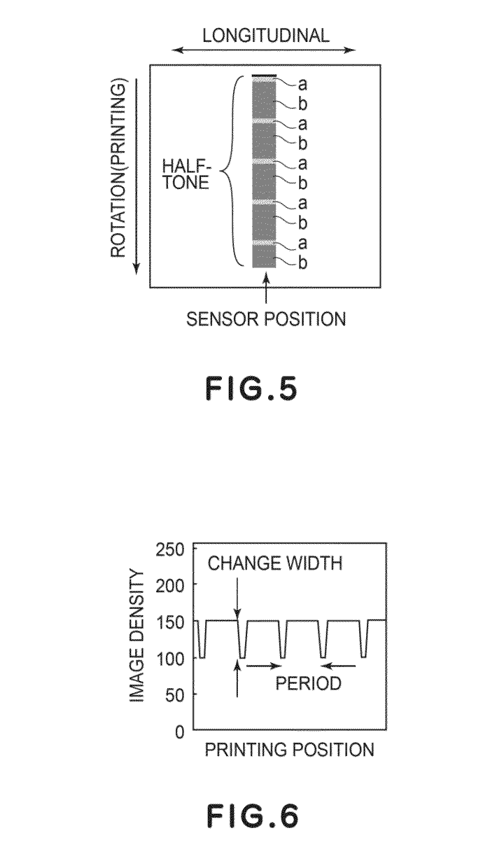

FIG. 5 shows an example in which when the charging roller 2 or the developing roller 41 is deformed in shape, a half-tone developer image is formed on the drum 1 and then is outputted on paper (recording material). In this case, a density difference (density fluctuation width) is generated between a portion a where the shape is deformed and a portion b where the shape is not deformed. Further, the density fluctuation width (density change width) becomes larger with an increasing degree of the shape deformation of the member, so that the member is not suitable for the recycling. Incidentally, when the recycling go/no-go discrimination of the member is made, the developer image is not outputted on the paper but is subjected to density measurement on the drum 1.

In the case where the charging roller 2 is shape-deformed, a period of density fluctuation generated on the drum 1 is an outer circumferential pitch of the charging roller 2. This is because the charging roller 2 is rotated by the rotation of the drum 1. In the case where the developing roller 41 is shape-deformed, a period of density fluctuation generated on the drum 1 is a ratio of (outer circumferential pitch of developing roller 41)/(peripheral speed ratio R). This is because the developing roller 41 is rotated at the peripheral speed ratio R relative to the rotational speed of the drum 1. Thus, the respective rotatable members in the cartridge E have individual density fluctuation periods.

In summary, as shown in FIG. 6, with respect to the rotatable member in the cartridge E, it is possible to check the presence of the member unsuitable for the recycling from a magnitude of the density fluctuation width (density change width), so that the member unsuitable for the recycling can be specified from the density fluctuation width.

In this embodiment, the density fluctuation width of the developer image is measured by using the density sensor 16, and in the case where the density fluctuation width exceeds a threshold, discrimination that there is shape deformation is made, and in the case where the density fluctuation width is not more than the threshold, discrimination that there is no shape deformation is made. However, under a normal image forming condition, a difference in density fluctuation width between the case of the shape deformation and the case of no shape deformation is small and therefore the discrimination cannot be made with accuracy. Therefore, in an operation in a control mode for discriminating the state of the rotatable member of the cartridge E, the developer image is formed under an image forming condition in which the density fluctuation width becomes larger than that under the normal image forming condition, and then whether or not the density fluctuation width is not more than a predetermined threshold is discriminated. As a result, the recycling go/no-go discrimination of the member can be made with high accuracy.

In this embodiment, in the operation in the control mode for discriminating the state of the rotatable member of the cartridge E, an analog half-tone developer image which has not been image-processed is formed in order to increase the density fluctuation width compared with that during the image formation. This is because compared with a digital half-tone developer image which has been image-processed, a charge potential non-uniformity resulting from the charging roller shape deformation and a development amount non-uniformity of the developer resulting from the developing roller shape deformation become conspicuous.

Specifically, respective pixels of the drum 1 are uniformly exposed to light, so that the charge potential non-uniformity resulting from the charging roller shape deformation can be maintained even after the exposure. Further, a half-tone density developer image capable of discriminating the charge potential non-uniformity due to the charging roller shape deformation and the development amount non-uniformity of the developer due to the developing roller shape change, with high accuracy.

That is, in the operation in the control mode for discriminating the state of the rotatable member of the cartridge E, the developer image is formed with the developer by exposing the respective pixels of the drum 1, on which the developer image is to be formed, to light under the same condition by the exposure device 3. Then, in the case where the density fluctuation width of the developer image is a predetermined value or more, discrimination that the rotatable member of the cartridge E has a large degree of consumption is made. Thus, in the case where the density fluctuation width of the half-tone density exceeds a predetermined threshold, the member is discriminated as being not recyclable, and in the case where the density fluctuation width is not more than the threshold, the member is discriminated as being recyclable. Then, a discrimination result is written in the non-volatile memory 14.

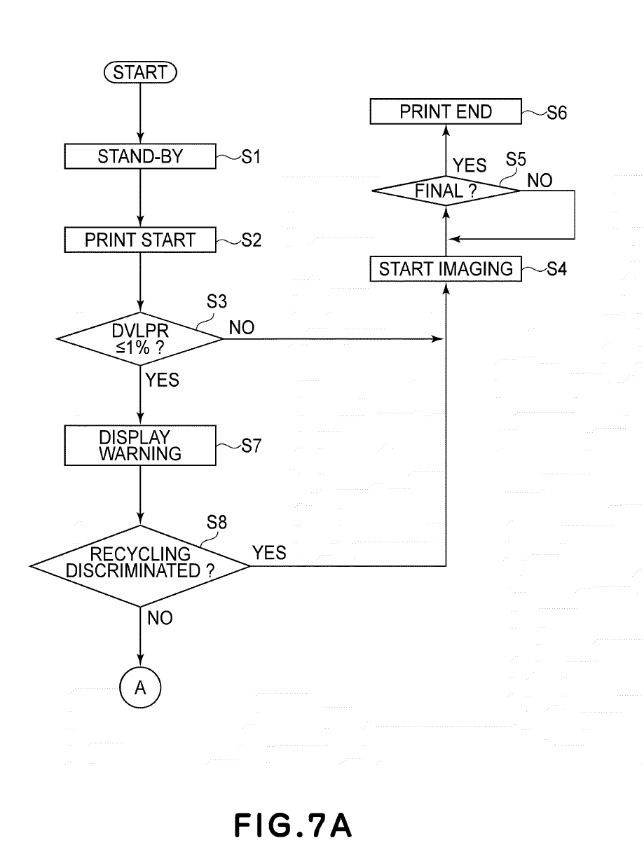

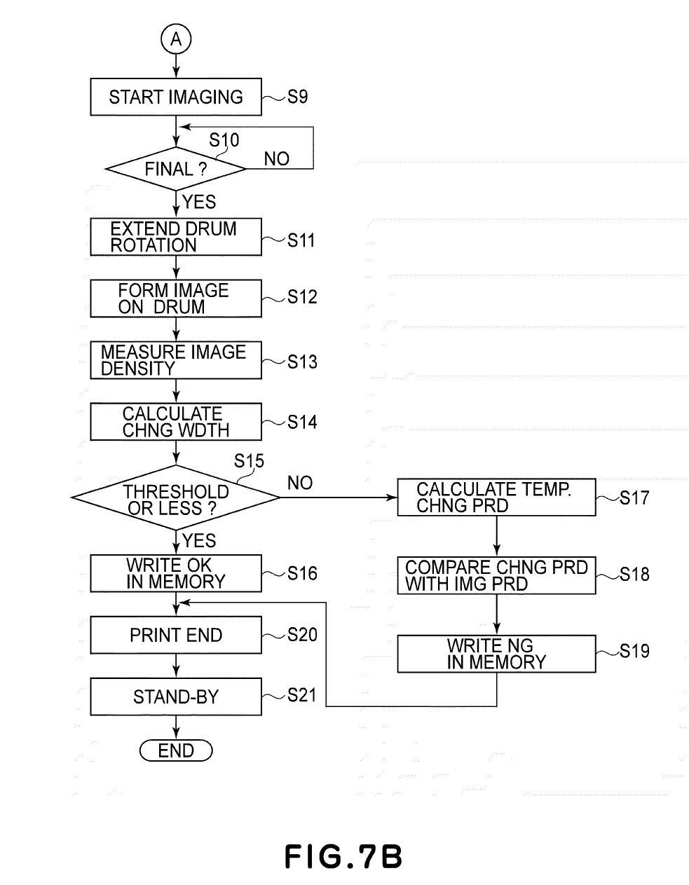

FIG. 7A and FIG. 7B show a control flow chart of the image forming apparatus in this embodiment. In a stand-by state of the image forming apparatus (step S1), when the engine controller C receives the printer command, the engine controller C actuates the main motor of the image forming apparatus to start a printing operation (S2).

The engine controller C discriminates, at the time of the print start, whether or not the remaining developer amount in the developer accommodating portion 44 of the cartridge E mounted in the apparatus main assembly A1 is 1% or less by the remaining developer amount detecting means 46 as described above (S3).

In the case where the remaining developer amount exceeds 1%, the image formation of an inputted print job is started, when printing of a predetermined number of sheets is effected, the printing is ended and the main motor is turned off to place the image forming apparatus in the stand-by state (S4 to S6 and S1).

Further, in step S3, in the case where the remaining developer amount is 1% or less, the engine controller C displays prewarning or warning of the end of the lifetime of the cartridge E at a displaying portion of the operating panel portion D or a displaying portion of the host device D (S7). Further, or not the recycling go/no-go discrimination of the rotatable member in the cartridge E has already been made is discriminated (S8). When the recycling go/no-go discrimination has already been made, the engine controller C starts the image formation of the inputted print job and then ends the printing when the printing of a predetermined number of sheets is effected, and thereafter turns off the main motor to place the image forming apparatus in the stand-by state (S4 to S6 and S1).

In step S8, when the recycling go/no-go discrimination has not been made, the engine controller C starts the image formation of the inputted print job and then executes printing of a predetermined number of sheets (S9 and S10). Then, the drum rotation after end of the printing of the predetermined number of sheets is extended (S11). Then, the condition is changed to the image forming condition for discriminating the state of the rotatable member in the cartridge E, and then the analog half-tone developer image is formed on the drum 1 (S12). Then, by using the density sensor 16, the density of the analog half-tone developer image is measured on the drum 1 (S13).

Incidentally, a length of time Δt in which the analog half-tone developer image is formed satisfies: Δt≧2×L/V where L (mm) is a longest image period of image periods of the rotatable image forming process member in the cartridge E, and V (mm/sec) is the peripheral speed of the drum 1. This is the length of time sufficient to be detected even in a density fluctuation period of any rotatable image forming process member in the cartridge E. That is, a length of the developer image with respect to the rotational direction of the drum 1 is not less than two times the image period of the rotatable image forming process member subjected to discrimination of the degree of consumption. This is because when the length is not less than two times the image period, the detection can be made at two positions or more if at least the deformation or the like is generated.

The engine controller C calculates, after the density of the analog half-tone developer image on the drum 1 is detected by the density sensor 16, calculates the density fluctuation width by the density fluctuation width calculating means (density fluctuation width calculating functional portion (S14)). Then, a calculation result of the density fluctuation width and a predetermined threshold are compared (S15). When the density fluctuation width is not more than the predetermined threshold, discrimination that a degree of consumption of all of the rotatable members in the cartridge E is small and thus all of the rotatable members in the cartridge E are recyclable is made, and then the state in which all of the rotatable members in the cartridge E are recyclable is written in the non-volatile memory 14 (S16).

In the case where the density fluctuation width exceeds the threshold, with respect to the density fluctuation width exceeding the threshold, a density fluctuation period is calculated by the density period calculating means (density period calculating functional portion) for calculating the density period of the developer image (S17).

In some cases, a plurality of density fluctuation periods are calculated in this embodiment. The calculated density fluctuation period and the image periods of all of the rotatable members in the cartridge E are compared, thus specifying a corresponding member (S18). In the case where the plurality of density fluctuation periods are calculated, each of the density fluctuation periods is compared with the image periods of all of the rotatable members in the cartridge E, thus specifying a corresponding member. However, in the case where the density fluctuation period and the image period of the member in the cartridge E is not the same, discrimination that all of the rotatable members in the cartridge E is recyclable is made.

The member having the density fluctuation period and the image period which are the same is discriminated as having a large degree of consumption, and then “recycling disable” is written in the non-volatile memory 14. Other all members in the cartridge are discriminated as having a small degree of consumption, and then “recycling enable” is written in the non-volatile memory 14 (S19). Then, the printing is ended (S20), and the main motor is turned off to place the image forming apparatus in the stand-by state (S21).

In the above steps, the steps S11 to S19 constitute the operation in the control mode for discriminating the state of the image forming process member (the developing roller 2 and the developing roller 41 in this embodiment) provided to the cartridge E. In the operation in the control mode, the developer image is formed under the image forming condition (in which the density fluctuation width is larger than that during the normal image forming condition in this embodiment) different from that during the normal image formation. Then, with respect to the formed developer image, from the density fluctuation width and the density fluctuation period which are detected by the density fluctuation calculating means and the period comparing means, the state of the image forming process member is discriminated, and then a discrimination result is stored in the non-volatile memory 14.

In this embodiment, the remaining developer amount detecting means 46 for detecting the remaining developer amount of the developer accommodating portion 44 in which the developer to be supplied to the developing roller 41 of the cartridge E is provided, and the engine controller C executes the operation in the control mode (S11 to S19) when the remaining developer amount detected by the remaining developer amount detecting means 46 reaches a predetermined value.

In the step S15 in FIG. 7B, the threshold of the density fluctuation width is the following value. That is, the threshold is a value at which the member in the cartridge can be discriminated, if the density fluctuation width is not more than the value, that the image defect is not generated during the use through the lifetime of the engine cartridge within the operation coverage range even when the member is reused as the constituent element of the brand-new cartridge.

As described above, by measuring the density fluctuation under the image forming condition different from that during the image formation, it is possible to check the presence of the member, with high accuracy, unsuitable for the recycling from the magnitude of the density fluctuation width, and it is possible to specify the member unsuitable for the recycling from the density fluctuation period. By writing the recycling go/no-go discrimination information of all of the rotatable members in the cartridge E into the non-volatile memory, there is no need to disassemble the cartridge in the factory and then to discriminate as to whether or not the image forming process member is recyclable. Further, in the case where there are the plurality of image forming process members in the cartridge, a part of the image forming process members are recyclable and a remaining part of the image forming process members are not recyclable in some instances. In such a case, when the image forming process member intended to be recycled is discriminated as being not recyclable and other image forming process members are discriminated as being recyclable, it is also possible to make discrimination that the cartridge is not disassembled and the image forming process members are not recycled. It would be considered that the cartridge which is not disassembled is subjected to recycling of a frame material.

Timing of the recycling go/no-go discrimination of the member in the cartridge E will be described. In order to normally form the analog half-tone developer image, the remaining developer amount in the developer accommodating portion 44 is required to be a predetermined value or more. Further, immediately before the use of the cartridge is ended, it is desirable that the state of the member is discriminated. Therefore, in this embodiment, the recycling go/no-go discrimination of the member in the cartridge E was made when the remaining developer amount in the developer accommodating portion 44 was 1%.

However, the present invention is not limited to this embodiment. For example, the recycling go/no-go discrimination of the member in the cartridge E may also be made when the remaining developer amount in the developer accommodating portion 44 is 2-10%. Further, the recycling go/no-go discrimination may also be made at the time, when the normal analog half-tone developer image is formable, such as the time when the developing device reaches the end of its lifetime or the time of warning of the developing device lifetime.

Further, in this embodiment, the recycling go/no-go discrimination is made only once when the remaining developer amount in the developer accommodating portion 44 is 1%, and then is determined, but is not necessarily limited to the time. For example, the recycling go/no-go discrimination of the member is started at the time when the remaining developer amount reaches a predetermined value A %, and then is determined at the time when the condition reaches a condition in which the recycling go/no-go discrimination of the member is difficult. Here, the condition in which the recycling go/no-go discrimination of the member is different refers to a condition in which the normal analog half-tone developer image cannot be formed due to an insufficient developer.

### Embodiment 3

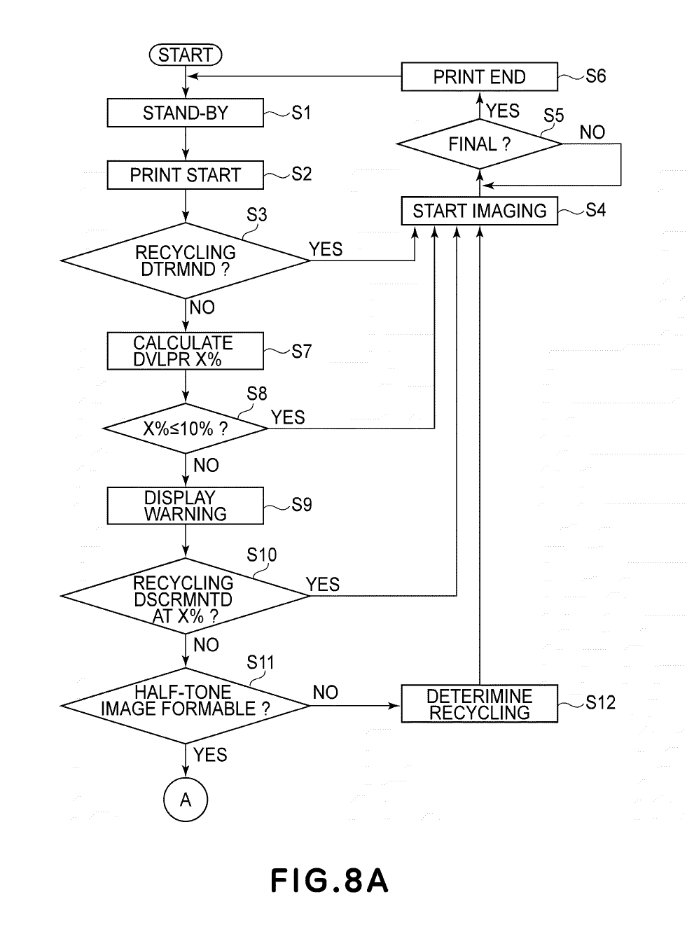

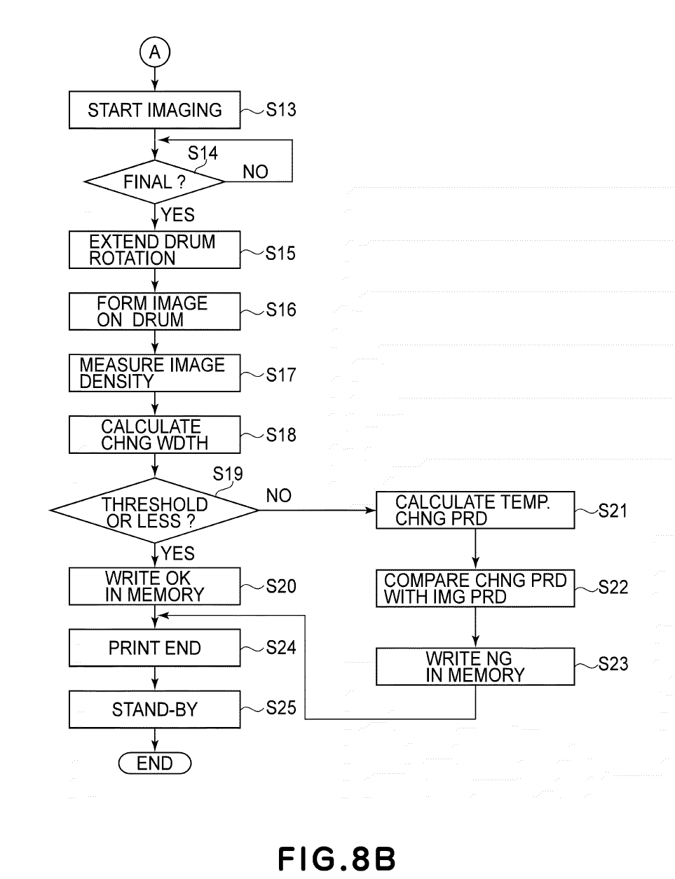

FIG. 8A and FIG. 8B show a control flow chart of the image forming apparatus in this embodiment as a supplemental example of Embodiment 2. In a stand-by state of the image forming apparatus (step S1), when the engine controller C receives the printer command, the engine controller C actuates the main motor of the image forming apparatus to start a printing operation (S2).

The engine controller C discriminates, at the time of the print start, whether or not the recycling go/no-go discrimination of the image forming process member in the cartridge E is determined (S3). In the case where the recycling go/no-go discrimination is determined, the image formation of the inputted print job is started and when printing of a predetermined number of sheets is effected, the printing is ended and then the main motor is turned off to place the image forming apparatus in the stand-by state (S4 to S6 and S1).

In the case where the recycling go/no-go discrimination is not determined, a remaining developer amount X % in the developer accommodating portion 44 is calculated (S7), and whether or not the remaining developer amount is not more than a predetermined value of 10% (S8). In the case where the remaining developer amount X % exceeds 10%, the image formation of an inputted print job is started, when printing of a predetermined number of sheets is effected, the printing is ended and the main motor is turned off to place the image forming apparatus in the stand-by state (S4 to S6 and S1).

Further, in step S3, in the case where the remaining developer amount X % is 10% or less, the engine controller C displays prewarning or warning of the end of the lifetime of the cartridge E at a displaying portion of the operating panel portion D or a displaying portion of the host device D (S9). Further, or not the recycling go/no-go discrimination has already been made is discriminated at the remaining developer amount X %, (S10). In the case where the recycling go/no-go discrimination has already been made at the remaining developer amount X %, the image formation of the inputted print job is started and when printing of a predetermined number of sheets is effected, the printing is ended, and then the main motor is turned off to place the image forming apparatus in the stand-by state (S4 to S6 and S1).

In the case where the recycling go/no-go discrimination has not been made at the remaining developer amount X %, whether or not the normal analog half-tone developer image can be formed is discriminated (S11). Specifically, under the normal image forming condition, the photosensitive drum is exposed to light for a predetermined time Δt2 at a maximum exposure amount, thus forming a solid developer image. The predetermined time Δt2 satisfies: Δt2≧2×L2/V where L2 (mm) is the image period of the developer carrying member and V (mm/s) is the peripheral speed of the photosensitive drum. Then a density difference Δd between an average density for first full-circumference of the developing roller 41 and that for a last full-circumference of the developing roller 41 is calculated.

In the case where the density difference Δd exceeds the predetermined value, discrimination that the developer is insufficient and thus the normal analog half-tone developer image cannot be formed is made. In this case, the recycling go/no-go discrimination of the member is determined (S12), and then the image formation of the inputted print job is started and then the printing is ended when the printing of a predetermined number of sheets is effected, and thereafter the main motor is turned off to place the image forming apparatus in the stand-by state (S4 to S6 and S1).

In the case where the density difference Δd is the predetermined value or less, discrimination that the developer is sufficient and thus the normal analog half-tone developer image is formable is made. Then, the image formation of the inputted print job is started and then printing of a predetermined number of sheets is executed (S13 and S14). Then, the drum rotation after end of the printing of the predetermined number of sheets is extended (S15). Then, steps S16 to S25 are the same as the steps S12 to S21 in FIG. 7.

### Other Embodiments

1) In Embodiments 1 to 3, the drum 1 and the transfer roller 5 are not spaced during the recycling go/no-go discrimination during the execution of the operation in the control mode for discriminating the state of the image forming process member included in the cartridge E, but may also be spaced. In the case where the drum 1 and the transfer roller 5 are spaced, during the developer image formation, it is possible to prevent the transfer roller 5 from being contaminated with the developer.

2) In Embodiments 1 to 3, the recycling go/no-go discrimination was effected with respect to the charging roller (charging member) 2 and the developing roller (developer carrying member) 41 but the member is not necessarily limited to these members. Any member can be subjected to the recycling go/no-go discrimination if the member is the rotatable member in the cartridge E. For example, the recycling go/no-go discrimination is also applicable to the supplying roller (developer supplying member) 42 for supplying the developer to the developing roller 41 and is applicable to the regulating roller (developer layer thickness regulating member) 43 for regulating the amount of the developer to be placed on the developing roller 41.

3) In Embodiments 1 to 3, as the means for measuring the density of the developer image on the drum 1, the density sensor 16 of a regular reflection type but the measuring means is not limited thereto. For example, the density sensor of a diffusion (reflection) type may also be used. Further, in the case where an image reading device is provided in the image forming apparatus, a test image for the recycling go/no-go discrimination may be outputted on the paper (recording material) and then its output image may be read to be subjected to density measurement.

4) In Embodiments 1 to 3, the developer image was formed on the drum 1 and then the recycling go/no-go discrimination was made but the present invention is not limited thereto. For example, the developer image may be formed on an intermediary transfer member and then the recycling go/no-go discrimination may be made.

5) The image forming apparatus is not limited to the image forming apparatus using the electrophotographic process but may also be those using an electrostatic recording process and using a magnetic recording process, and the like process.

6) In Embodiments 1 to 3, at the controller of the image forming apparatus, the state of the image forming process member is discriminated and its discrimination result is stored in the memory but the present invention is not limited thereto. For example, in Embodiment 1, the measured density may also be stored, as information for discriminating the state of the image forming process member, in the memory. In that case, before the disassembling of the cartridge in the factory, the information stored in the memory is read and displayed on a display device or the like, and then a user may discriminate, from the measured density, whether or not the image forming process member is recyclable. Even in this case, there is the information directly relating to the state of the image forming process member and therefore the recycling go/no-go discrimination of the image forming process member can be effected without disassembling the cartridge, so that cumbersome disassembling can be eliminated.

7) For that reason, the information stored in the memory may be not only the result of the recycling go/no-go discrimination but also may only be required to be information capable of discriminating the state of the image forming process member. For that reason, as the information for discriminating the state of the image forming process member, it would be considered that it is possible to use the measured density, information that the measured density is the predetermined value or more, and the information on whether or not the image forming process member is recyclable. These may be stored as individual information in the memory but may also be stored in combination of plural pieces of the information.

8) In Embodiments 1 to 3, the description is made by using the non-volatile memory, but the memory may only be required to store the information and therefore is not limited to the non-volatile memory.

While the invention has been described with reference to the structures disclosed herein, it is not confined to the details set forth and this application is intended to cover such modifications or changes as may come within the purpose of the improvements or the scope of the following claims.

This application claims priority from Japanese Patent Applications Nos. 047848/2012 filed Mar. 5, 2012 and 033017/2013 filed Feb. 22, 2013, which are hereby incorporated by reference.

What is claimed is:

1. An image forming apparatus for forming an image on a recording material, comprising:
a cartridge, detachably mountable to a main assembly of said image forming apparatus, including a memory and an image forming process member actable on an image bearing member in an image forming process; and
image density measuring means, provided in the main assembly, for measuring a density of a developer image formed by the image forming process,
wherein said memory stores information for discriminating a state of the image forming process member on the basis of the density, measured by said image density measuring means, of the developer image formed under an image forming condition different from that during normal image formation.

2. An image forming apparatus according to claim 9, wherein the information for discriminating the state of the image forming process member includes at least one of the measured density, information that the measured density is not less than a predetermined value, and recycling go/no-go information of the image forming process member.

3. An image forming apparatus according to claim 1, further comprising a controller for storing in said memory the information for discriminating the state of the image forming process member on the basis of the value of the density, measured by said image density measuring means, of the developer image formed under the image forming condition different from that during the normal image formation.

4. An image forming apparatus according to claim 1, wherein the image forming process member is any one of a charging member for electrically charging the image bearing member, a developer carrying member for developing with a developer a latent image formed on the image bearing member, a developer feeding member for feeding the developer to the developer carrying member, and a developer layer thickness regulating member for regulating an amount of the developer to be placed on said developer carrying member.

5. An image forming apparatus according to claim 1, wherein said cartridge includes the image bearing member.

6. An image forming apparatus according to claim 1, wherein said cartridge includes a charging member for electrically charging the image bearing member and a developer carrying member for developing with a developer a latent image held on the image bearing member, and
wherein when a charge potential of the image bearing member is Vd, a DC voltage to be applied to the image bearing member is Vder, and an absolute value of a difference between Vd and Vder is Vback,
the information for discriminating the state of the image forming process member is information on the basis of a density obtained by forming the developer image under a condition in which Vback is larger than that during the normal image formation and then by measuring the density of the formed developer image at a portion of Vd by said image density measuring means.

7. An image forming apparatus according to claim 1, further comprising a density fluctuation width calculating means for calculating a density fluctuation width on the basis of the density of the developer image measured by said image density measuring means.

8. An image forming apparatus according to claim 1, further comprising a density period calculating means for calculating a density period of the developer image.

9. An image forming apparatus according to claim 1, wherein information for discriminating a state of a specific image forming process member of a plurality of image forming process members is calculated from a density fluctuation width calculated by a density fluctuation width calculating means and a density period calculated by a density period calculating means.

10. An image forming apparatus according to claim 1, wherein a length of the developer image with respect to a rotational direction of the image bearing member is not less than two times an image period of the image forming process member to be subjected to discrimination of a degree of consumption.

11. An image forming apparatus according to claim 1, further comprising a remaining developer amount detecting means for detecting a remaining developer amount of a developer accommodating portion in which the developer is accommodated,
wherein when the remaining developer amount detected by said remaining developer amount detecting means reaches a predetermined value, the density of the developer image is measured by said image density measuring means.

12. An image forming apparatus according to claim 1, further comprising a lifetime calculating means for the image bearing member,
wherein when a lifetime of the image bearing member calculated by said lifetime calculating means reaches a predetermined value, said controller measures the density of the developer image by said image density measuring means.

13. A cartridge recycling detecting system in an image forming apparatus for forming an image on a recording material, said cartridge recycling detecting system, comprising:
a cartridge, detachably mountable to a main assembly of said image forming apparatus, including a memory and an image forming process member actable on an image bearing member in an image forming process; and
image density measuring means, provided in the main assembly, for measuring a density of a developer image formed by the image forming process,
wherein said memory stores information for discriminating a state of the image forming process member on the basis of the density, measured by said image density measuring means, of the developer image formed under an image forming condition different from that during normal image formation.
